(19) United States
(12) Patent Application Publication
(10) Pub. No.: US 2016/0223186 A1
(43) Pub. Date: Aug. 4, 2016

(54) LIQUID CANDLE SYSTEM

(71) Applicant: KOMI ORI LTD., Ofakim (IL)

(72) Inventor: Yosi AZAR, Ofakim (IL)

(21) Appl. No.: 14/917,608

(22) PCT Filed: Sep. 9, 2014
(86) PCT No.: PCT/IL2014/050799

§ 371 Date: Mar. 9, 2016

(30) Foreign Application Priority Data
Sep. 9, 2013 (IL) 228306

(51) Int. Cl. F21V 37/00; F23D 3/16; F21V 35/00; C11C 5/00

(52) U.S. Cl. CPC F21V 37/0008; C11C 5/006; F23D 3/16; F21V 35/00; F21V 37/002

(57) ABSTRACT

The present disclosure provides a candle system comprising a fuel recipient comprising a self-collapsing cavity configured for receiving a predetermined liquid fuel; and a wick, wherein the self-collapsing cavity is configured for progressively collapsing when the cavity is filled with the predetermined liquid fuel and the wick is lit.

### TECHNOLOGICAL FIELD

The present disclosure relates generally to liquid candle systems. More particularly, the present disclosure relates to a liquid candle system including a self-collapsing fuel recipient.

### BACKGROUND

In contrast to electrical lighting or a flashlight, a candle is a natural source of light. Candles provide warmth and a pleasant, special ambience, yet do not provide as much light as a modern light bulb.

A candle generally comprises two elements: a wick and a candle body. Candles can be divided into two categories: solid candles and liquid candles. In solid candles, the candle body is made of a solid fuel such as wax or solid paraffin. In use i.e. when the wick is lit by a flame, the heat of the flame melts a part of the solid fuel which then moves upward through the wick via capillary action and finally vaporizes to burn within the candle's flame. In liquid candles, the candle body is made of a liquid fuel such as oil or liquid paraffin stored in a fuel recipient. In use, the liquid fuel directly moves through the wick and vaporizes within the candle's flame.

Generally, light generated by a liquid candle, and particularly by a candle fed with olive oil, provides better aesthetic qualities than light generated by typical wax candles. However, using liquid candles presents several difficulties as explained below with reference to FIGS. 1A-1C.

FIG. 1A illustrates a first variety of a liquid candle according to the prior art. The liquid candle comprises a fuel recipient 1 receiving a liquid fuel 2 and a wick 3 arranged on a floater 4 floating at the surface of the liquid fuel 2. When the wick 3 is lit by a flame 5, the liquid fuel 2 is progressively consumed and the flame 5 falls progressively within the fuel recipient 1 because the wick 3 is arranged on the floater 4. This decreases the visibility of the flame 5 for an observer watching the candle system laterally i.e. from a direction perpendicular to the drawing plane. Furthermore, the visibility of the flame may additionally be limited by the presence of dark smoke deposited on the walls of the fuel recipient.

FIG. 1B illustrates a second variety of a liquid candle according to the prior art. In order to overcome the problem described hereinabove, it has been proposed to add a second liquid 6 of density superior to the density of the liquid fuel 2 in the fuel recipient 1. This prevents the flame 5 from reaching the bottom of the fuel recipient 1 because the second liquid 6 does not burn. However, this second variety of liquid candle has a reduced burning time than the first variety because the amount of liquid fuel is lower and presents a further drawback of requiring an additional liquid.

FIG. 1C illustrates a third variety of a liquid candle according to the prior art. In the third variety, a lower part of the wick 3 is fixed at the bottom of the fuel recipient 2 and an upper part of the wick 3 is held by a clip 8 so as to protrude out of the fuel recipient 1. This prevents the flame 5 from falling within the fuel recipient 1. However, because the distance between the liquid fuel 2 and the flame 5 is higher than in the first and second varieties, the amount of liquid fuel 2 reaching the flame 5 by capillarity is reduced and the light produced is therefore weaker.

### GENERAL DESCRIPTION

The present disclosure provides a novel liquid candle system which at least partially overcome the drawbacks of liquid candle systems in the prior art.

The Applicant hereby proposes a liquid candle system comprising a self-collapsing fuel recipient which enables to improve visibility of the light generated by the liquid candle. A main idea of the present disclosure is to prevent hiding of the burning wick within the fuel recipient by using a progressively self-collapsing fuel recipient. As will be described herein, different techniques can be used to obtain a fuel recipient which progressively self-collapses with the burning of the liquid candle. In some embodiments, the fuel recipient may be composed of a fusible material such that heat generated by the liquid candle, when it is lit, progressively fuses an edge of the fuel recipient. In some embodiments, the fuel recipient may be composed of a stretching material which is stretched by the liquid fuel, when the liquid fuel is accommodated in the fuel recipient, and which collapses with the liquid fuel being consumed. In some other embodiments, the fuel recipient may include a floating edge and a side wall of the fuel recipient may be formed by a foldable film configured for collapsing when the liquid fuel is burnt and the floating edge collapses.

Generally, the liquid candle may include a wick arrangement comprising at least one wick. The wick may be arranged on a floater or may be coupled to the fuel recipient.

Therefore, the present disclosure provides a candle system comprising a fuel recipient comprising a self-collapsing cavity configured for receiving a predetermined liquid fuel; and a wick. The self-collapsing cavity is configured for progressively collapsing when the cavity is filled with the predetermined liquid fuel and the wick is lit.

In some embodiments, the wick is configured so that a first end of the wick protrudes out of an opening of the cavity when the self-collapsing cavity is filled with the predetermined liquid fuel.

In some embodiments, the self-collapsing cavity is configured for collapsing at a pace similar to a decline pace of the predetermined liquid fuel in the cavity.

In some embodiments, the self-collapsing cavity is composed of a stretching material, such that, when the predetermined liquid fuel is accommodated in the self-collapsing cavity, the self-collapsing cavity is stretched out by the predetermined liquid fuel, and when the cavity is filled with the predetermined liquid fuel and the wick is lit, the self-collapsing cavity stretches in with the predetermined liquid fuel being consumed.

In some embodiments, the self-collapsing cavity is circumscribed by a side wall formed by a foldable film suspended to a floating edge so that the self-collapsing cavity expands when filled with the predetermined liquid fuel, and shrinks with the predetermined liquid fuel being consumed when the wick is lit.

In some embodiments, the self-collapsing cavity is circumscribed by a side wall composed of a fusible material and the candle system is configured so that, when the cavity is filled with the predetermined liquid fuel and the first end of the wick is lit, an edge of the side wall fuses.

In some embodiments, the candle system further comprises a volume of the predetermined liquid fuel accommodated in the cavity.

The present disclosure provides in another aspect a candle system comprising a fuel recipient comprising a self-collapsing cavity configured for receiving a predetermined liquid fuel; and a wick; wherein the candle system is further configured so that, when a predetermined volume of liquid fuel is inserted in the self-collapsing cavity, a first end of the wick protrudes out of the liquid fuel and, the first end of the wick being lit, the self-collapsing cavity collapses at a pace similar to a decline pace of the predetermined liquid fuel in the cavity.

In some embodiments, the self-collapsing cavity is composed of a stretching material such that, when the predetermined liquid fuel is accommodated in the self-collapsing cavity, the self-collapsing cavity is stretched out by the predetermined liquid fuel, and when the predetermined liquid fuel is consumed, the self-collapsing cavity collapses.

In some embodiments, the self-collapsing cavity is circumscribed by a side wall formed by a foldable film suspended to a floating edge configured to float on the predetermined liquid fuel so that when the cavity is filled with the predetermined liquid fuel and the first end of the wick is lit, the floating edge falls with the predetermined liquid fuel being consumed.

In some embodiments, the self-collapsing cavity is circumscribed by a side wall composed of a fusible material and the candle system is configured so that, when the cavity is filled with the predetermined liquid fuel and the first end of the wick is lit, an edge of the side wall fuses.

In some embodiments, when the cavity is filled with the predetermined liquid fuel and the first end of the wick is lit, a fusion of the edge of the side wall causes an opening of the cavity to decline at a pace similar to the pace at which the predetermined liquid fuel in the cavity declines.

In some embodiments, the predetermined amount of liquid fuel fills the cavity up to an opening of the cavity.

In some embodiments, the candle system is further configured so that the flame is visible out of the cavity during burning of the liquid fuel.

In some embodiments, the candle system further comprises the predetermined volume of the predetermined liquid fuel accommodated in the cavity.

The present disclosure provides in another aspect a candle system comprising: a fuel recipient comprising a self-collapsing cavity configured for receiving a predetermined liquid fuel; a volume of the predetermined liquid fuel accommodated in the cavity so that the cavity is filled up to a reservoir surface; a wick configured so that a first end of the wick protrudes out of the reservoir surface; wherein the self-collapsing cavity is configured for progressively collapsing when the first end of the wick is lit.

In some embodiments, the self-collapsing cavity is configured for collapsing, when the first end of the wick is lit, at a pace similar to a decline pace of the predetermined liquid fuel in the cavity.

In some embodiments, the self-collapsing cavity is composed of a stretching material such that, the self-collapsing cavity is stretched out by the predetermined liquid fuel, and when the predetermined liquid fuel is consumed, the self-collapsing cavity progressively collapses.

In some embodiments, the self-collapsing cavity is circumscribed by a side wall formed by a foldable film suspended to a floating edge configured to float on the predetermined liquid fuel so that when the cavity is filled with the predetermined liquid fuel and the first end of the wick is lit, the floating edge falls with the predetermined liquid fuel being consumed.

In some embodiments, the self-collapsing cavity is circumscribed by a side wall composed of a fusible material and the candle system is configured so that, when the first end of the wick is lit, an edge of the side wall fuses.

In some embodiments, the reservoir surface reaches an opening of the cavity.

In some embodiments, the candle system is further configured so that the flame is visible out of the cavity during burning of the liquid fuel.

In some embodiments, further comprising a floater capable of floating on the predetermined liquid fuel and wherein the wick is arranged on the floater.

In some embodiments, a second end of the wick is coupled to the self-collapsing cavity.

In some embodiments, the candle system further comprises a wick coating configured for strengthening the wick.

In some embodiments, the wick coating is composed of a fusible material.

In some embodiments, the wick coating is made of solid paraffin and/or wax.

In some embodiments, the predetermined liquid fuel is olive oil.

In some embodiments, a volume of the cavity up to the opening or up to the reservoir surface is adapted for enabling lighting of the candle system over a given period of time selected in the range from 30 minutes to 1 week, when the cavity is filled with olive oil.

In some embodiments, the volume of the cavity up to the opening or up to the reservoir surface is adapted for enabling lighting of the candle system over a period of time selected from: 40 min, 90 min, 3 h, 6 h, 8 h, 24 h, 48 h, 72 h, 1 week, when the cavity is filled with olive oil.

In some embodiments, the candle system further comprises a fusible cover configured for covering the cavity, the wick being further configured for protruding out of the fusible cover, wherein the fusible cover is configured for fusing when the first end of the wick is lit.

In some embodiments, the fusible cover is composed of paraffin and/or wax.

In some embodiments, the candle system further comprises one or more additional wick arrangements.

In some embodiments, the candle system further comprises one or more additional fuel recipients.

The present disclosure provides in another aspect a candle kit comprising one or more candle systems as previously described; and one or more olive oil containers containing olive oil.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A-1C, already described, illustrate cross-sections views of liquid candle systems according to the prior art.

FIGS. 2A and 2B illustrate respectively a lateral cross-section and an upper view of a fuel recipient according to some embodiments of the present disclosure.

FIG. 3 illustrates a lateral cross-section view of a candle system prior to and during lighting according to some embodiments of the present disclosure.

FIG. 4 illustrates a lateral cross-section view of a candle system prior to and during lighting according to some embodiments of the present disclosure.

FIGS. 5A and 5B illustrate lateral cross-section views of candle systems including a waste collection mechanism according to embodiments of the present disclosure.

FIGS. 6A and 6B illustrate lateral cross-section views of candle systems including a fusible cover according to embodiments of the present disclosure.

FIGS. 7A and 7B illustrate lateral cross-section views of candle systems according to embodiments of the present disclosure.

FIG. 8 illustrates a lateral cross-section view of a candle system prior to and during lighting according to some embodiments of the present disclosure.

FIG. 9 illustrates a perspective view of a candle system prior to and during lighting according to some embodiments of the present disclosure.

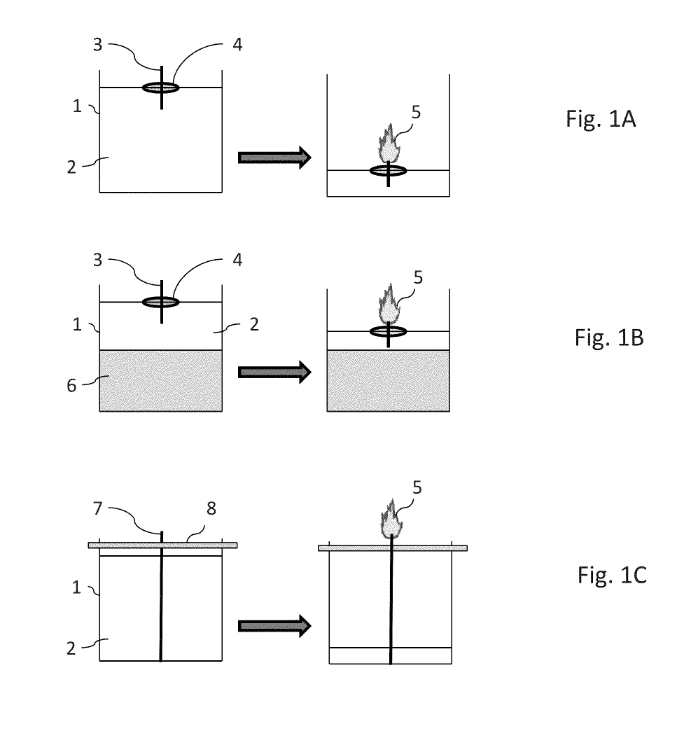

Similar references on different figures may refer to similar elements, unless otherwise indicated.

### DETAILED DESCRIPTION OF EMBODIMENTS

Described herein are some examples of liquid candle systems.

It is understood that the term “fusible” refers to a material that melts easily with respect to heat generated in the vicinity of a candle. In particular, in the present disclosure the term “fusible” refers to materials that would melt under the conditions disclosed in the description. For example, the side wall is composed of a fusible material so that the heat generated by the lit wick causes an edge of the side wall to fuse.

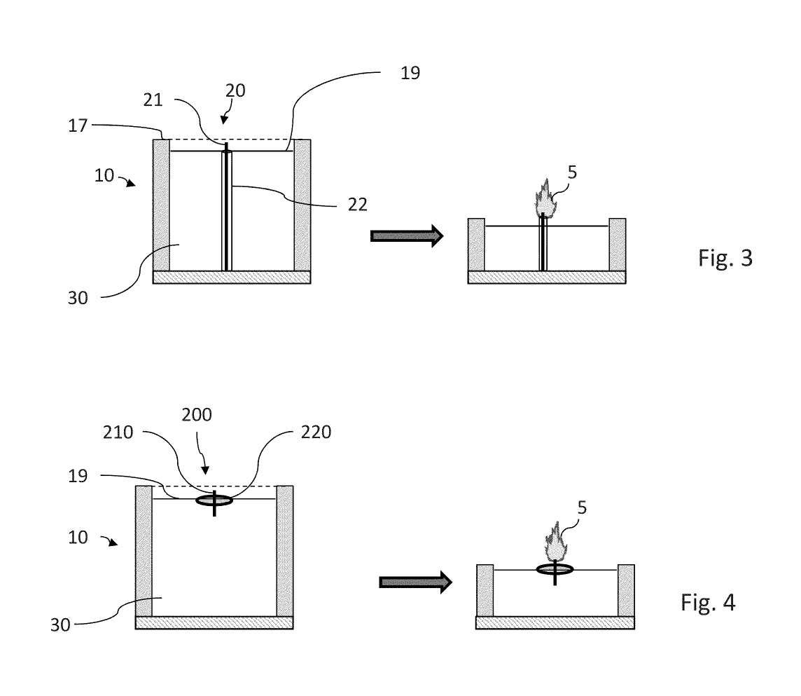

The term collapsing refers to a vertical contraction (vertical shrinking). It is noted that the vertical contraction of the cavity may refer to a contraction along a longitudinal axis of the cavity. The longitudinal axis may refer to an axis of extension of the cavity. In the following description and/or claims, it is understood that the terms “vertical,” “horizontal,” “up”, “down” and the like are generally used to refer to directions with reference to a standard position of the candle system as shown for example on FIGS. 3 and 4 i.e. wherein the opening of the fuel recipient is oriented opposite to the support on which it is held so that the liquid fuel stays in the fuel recipient.

Further, the term “liquid fuel” should be understood as referring to a fuel adapted for candle lighting which is liquid under room conditions of temperature and pressure, particularly, in the absence of the wick being lit. For example, the liquid fuel may consist of olive oil.

Furthermore, it is noted that the claims generally aim at describing a candle system in its original state i.e. as it stands prior to lighting. In other words, the features disclosed for describing the candle system should be understood as describing the candle system in an unused state in contrast to a used state in which the candle system has already been lit for a substantial amount of time so that its original shape and/or characteristics may have been modified.

In the following detailed description, numerous specific details are set forth in order to provide a thorough understanding of the subject matter. However, it will be understood by those skilled in the art that some examples of the subject matter may be practiced without these specific details.

As used herein, the phrase “for example,” “such as”, “for instance” and variants thereof describe non-limiting examples of the subject matter.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one example of the subject matter, but the appearance of the same term does not necessarily refer to the same example.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination. In particular, it is understood that the two embodiments of the wick arrangement described (i.e. the wick arranged on a floater or coupled to the fuel recipient) can be apprehended in the various embodiments of the self-collapsing fuel recipient according to the present disclosure.

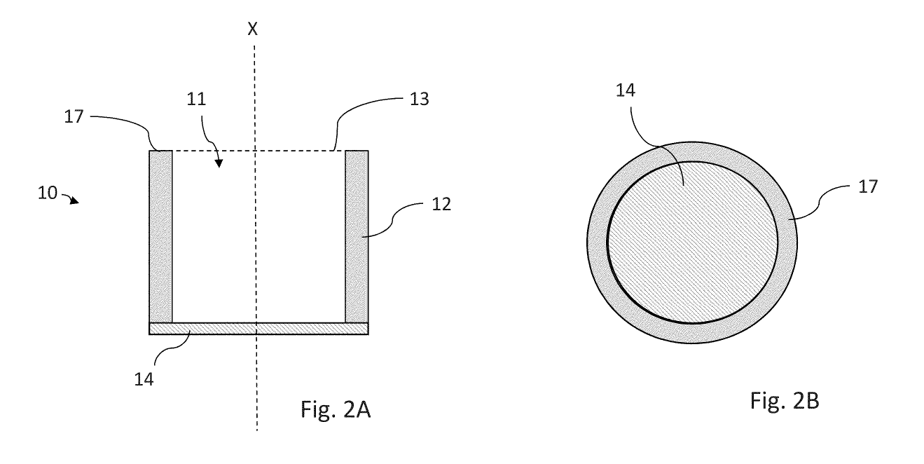

FIGS. 2A and 2B illustrate a fuel recipient 10 of a candle a system including a self-destroying cavity according to some embodiments of the present disclosure. The fuel recipient 10 may comprise a sidewall 12 circumscribing (surrounding) laterally a cavity 11. An edge (upper crest) 17 of the sidewall 12 may define an opening 13 of the cavity 11 and a base wall 14 of the fuel recipient may form a bottom end of the cavity 11. The cavity 11 may form a recess configured for receiving a predetermined liquid fuel, for example olive oil. The opening 13 may enable fluid introduction in the cavity 11. The sidewall 12 may be composed of a fusible material. The fusible material may for example be composed of any one or combination of the following materials: stearin, bees wax, fats, etc. The base wall 14 may also be made of a fusible material. In some embodiments, the base wall 14 may be integral with the sidewall 12. In some embodiments, the base wall 14 may be coupled to the sidewall 12 but may be made of a different material (fusible or not fusible). In some embodiments, the sidewall 12 may have an annular horizontal cross-section thereby defining a tubular cavity 11. Generally, the sidewall 12 may have an axially symmetric shape with respect to a central axis X (vertical axis) of the cavity 11. In some embodiments, the cavity may have a rectangular or square horizontal cross-section.

FIG. 3 illustrates a first variant of a candle system according to embodiments of the present disclosure. For the sake of conciseness and clarity, certain characteristics of the fuel recipient as well as certain reference numbers associated to elements of the fuel recipient are not repeated in FIG. 3 and in the below description. The candle system may comprise a fuel recipient 10 as previously described and a wick 21 configured so that a first end of the wick 21 protrudes out of a reservoir surface 19 of the cavity. As illustrated, in the first variant, a second end of the wick 21 may be coupled to the base wall (preferably along the X axis) and extend beyond the reservoir surface 19 or preferably above the opening of the cavity. In fact, the reservoir surface 19 could be understood as a tolerance level below the opening surface. The level of the reservoir surface 19 may depend on the other characteristics of the candle system such as a sidewall/wick composition and/or a thickness of the sidewall. It is understood that the term reservoir surface refers to a level within the cavity, wherein the level may be measured with regard to a vertical axis of the cavity, for example the X axis previously defined. When the wick emerges from the reservoir surface 19 and the liquid fuel fills the cavity up to the reservoir surface 19, the desired effect of controlled fusion of the edge of the sidewall can occur. When the wick does not reach the reservoir surface 19, the desired effect may not occur. It is noted that in the first variant of the candle system the first end of the wick 21 may protrude out of the reservoir surface 19 when the cavity is filled at least up to the reservoir surface 19 with the predetermined liquid fuel 30 as well as when the cavity is not filled up to the reservoir surface 19 with the predetermined liquid fuel 30. The reservoir surface 19 may be parallel to the opening of the cavity. The reservoir surface 19 may be marked by a gauge indication on an inner surface of the sidewall 12 facing the cavity. The reservoir surface 19 may be proximate to the opening of the cavity so that when the wick 21 is lit by a flame, the flame is visible (or is mostly visible) out of the cavity. The reservoir surface 19 may be configured so that when the wick 21 is lit by a flame, the heat generated by the flame causes the edge 17 of the sidewall to fuse. In some embodiments, the reservoir surface 19 and the opening of the cavity may be superimposed. The candle system may further comprise a wick coating 22 configured for strengthening the wick 21 which, together with the wick 21, may form a wick arrangement 20. The wick coating 22 may be composed of one or more fusible materials, for example stearin, bee wax, fats, etc. The wick coating 22 may be porous at least in certain regions of the wick 21. The wick may alternatively be a stiff wick as commonly used by a man skilled in the art.

The sidewall and the wick 21 may be configured so that, when the cavity contains liquid fuel 30 and the first end of the wick 21 is lit by a flame 5, the liquid fuel 30 feeds the flame 5 and heat generated by the flame 5 causes the edge 17 of the side wall to fuse. In some embodiments, when the cavity is filled with liquid fuel 30 up to the reservoir surface 19 of the cavity and the first end of the wick 21 is lit, the edge 17 of the sidewall fuses. This causes the opening of the cavity to follow a decrease of the predetermined liquid fluid in the cavity. This enables the flame 5 to stay visible out of the cavity during burning of the liquid fuel 30. Preferably, the opening of the cavity may decline at a pace similar to the pace at which the predetermined liquid fuel 30 declines. In other words, a geometry of the cavity, a position of the wick as well as burning characteristics of the wick/predetermined liquid fuel/sidewall may be designed so that the heat generated by the wick is capable of fusing an edge of the side wall at the desired pace. For example, a basic method for manufacturing the above described candle system may comprise digging a tubular cavity around the wick of a classical candlestick. A more advanced method could comprise casting and or dipping, etc.

FIG. 4 illustrates a second variant of a candle system according to embodiments of the present disclosure. The mere difference between the first and the second variant relates to how the wick is configured for the first end of the wick to protrude out of the reservoir surface. The below description therefore focuses on the discrepancies with respect to the first variant, being understood that details described in the first variant are generally compatible with the second variant. The candle system comprises a fuel recipient 10 as previously described and a wick 210. The candle system further comprises a floater 220 configured for floating on the predetermined liquid fuel 30. The wick 210 may be arranged on the floater 220 so that the wick 210 protrudes out of both a first and second faces of the floater 220. The floater 220 and the wick 210 may form a wick arrangement 200. The candle system may further be configured so that, when a predetermined volume of the liquid fuel 30 is accommodated in the cavity, a first end of the wick 210 protrudes out of the reservoir surface 19. It is noted that, in the second variant, the protrusion of the first end of the wick out of the reservoir surface 19 is dependent on the presence of a predetermined volume of liquid fuel in the cavity. Furthermore, the sidewall 12, the wick 21 (i.e. notably its composition and size) and the reservoir surface 19 (i.e. a minimum volume of liquid fuel to be accommodated in the cavity) may be configured so that, when the cavity 11 contains liquid fuel 30 at least up to the reservoir surface 19 and the first end of the wick 21 is lit by a flame 5, the liquid fuel 30 feeds the flame 5 and heat generated by the flame 5 causes the edge 17 of the side wall 12 to fuse. As explained above, in the second variant, a position of the wick depends on a volume of liquid fuel inserted in the cavity. In some embodiments, when the cavity is filled with liquid fuel 30 up to the reservoir surface 19 of the cavity and the first end of the wick 21 is lit, the edge 17 of the sidewall 12 fuses thereby causing the opening of the cavity to follow a decrease of the predetermined liquid fluid in the cavity. This enables the flame 5 to stay visible out of the cavity during the burning of the liquid fuel 30. Preferably, the opening of the cavity may decline at a pace similar to the pace at which the predetermined liquid fuel 30 declines. In other words, a geometry of the cavity, a position of the reservoir surface (i.e. a predetermined volume of liquid fuel to be inserted in the candle system) as well as burning characteristics of the wick/liquid fuel/sidewall may be selected so that the heat generated by the wick is capable of fusing an edge of the side wall at the desired pace. Therefore, the candle system may be configured so that when the predetermined volume of liquid fuel 30 is accommodated in the cavity and the first end of the wick is lit, an edge 17 of the side wall fuses and causes an opening of the cavity to decline at a pace similar to the pace at which the predetermined liquid fuel declines in the cavity. It is understood that the decline rate of the liquid fuel as well as the decline rate of the opening of the cavity may for example be measured with respect to the X vertical axis. In some embodiments the floater 220 may be shaped so as to substantially cover the reservoir surface 19. As described above, in some embodiments, the reservoir surface may lay on the opening of the cavity.

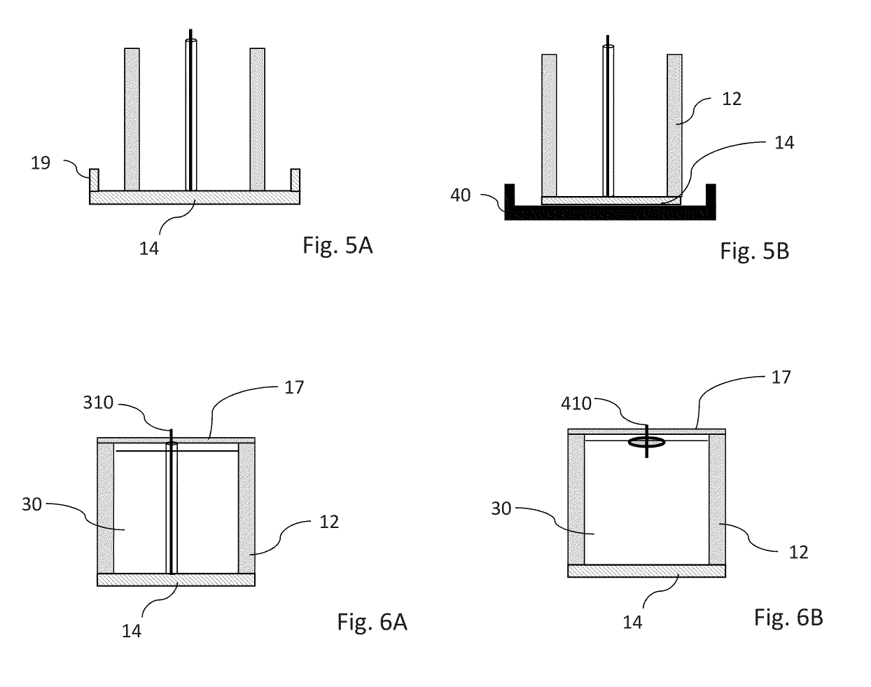

FIGS. 5A and 5B illustrate embodiments of the candle system further comprising a waste collection mechanism. In some embodiments as shown on FIG. 5A, the base wall 14 may extend laterally so as to collect waste from the combustion of the liquid fuel and the melting of the side wall. The base wall 14 may optionally comprise a peripheral ridge 19. In some alternative embodiments, as shown on FIG. 5B, the candle system may alternatively include a pan 40 arranged below the base wall 14.

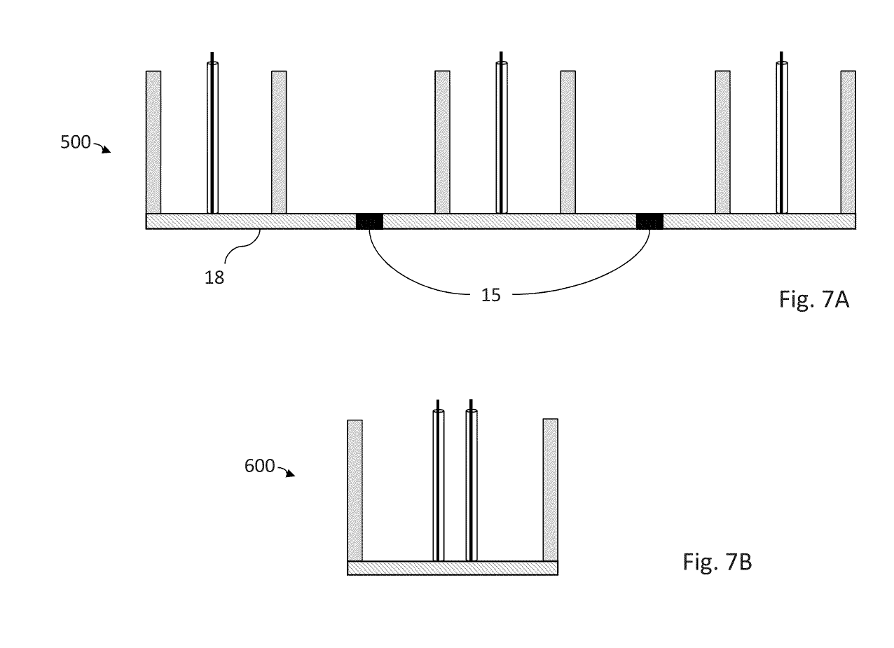

FIGS. 6A and 6B illustrate respectively embodiments of the first and second variants of the candle system previously described, further including a fusible cover 17 configured for covering the opening of the cavity. As shown on FIGS. 6A and 6B, the candle system may further include the predetermined liquid fuel 30. In the first variant described on FIG. 6A, the wick 310 is further configured for protruding out of the fusible cover 17. The fusible cover 17 is configured for fusing when the first end of the wick 310 is lit. As shown on FIG. 6B, the candle system according to the second variant may further include a predetermined amount of liquid so as to project the first end of the wick 410 out of the fusible cover 17. The fusible cover 17 enables particularly to transport the candle system easily. The fusible cover 17 may be composed of one or more fusible materials such as stearin, fats, wax, paraffin, etc.

FIGS. 7A and 7B provide respectively two examples of candle systems 500, 600 according to some embodiments of the present disclosure. The candle system 500 may include several candle systems as previously disclosed. In some embodiments, said candle systems may share a common base wall 18. Further, the shared base wall 18 may include cutting portions 15 configured for enabling cutting the shared base wall 18 to a desired size thereby including a given number of candle systems. In some embodiments, two cutting portions 18 may be arranged adjacent to the candle systems on each portion of the side wall 15 joining two candle systems. The candle system 600 comprises a self-destroying fuel recipient as previously described and two wicks. In some embodiments, more than two wicks may be disposed in the fuel recipient.

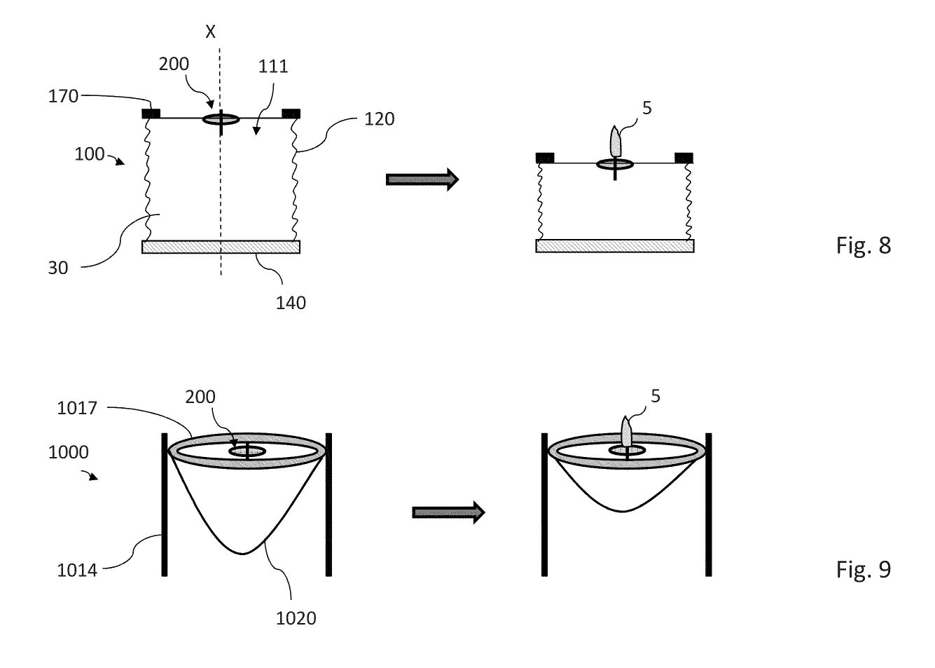

FIG. 8 illustrates a candle system according to a third variant including a self-collapsing cavity according to some embodiments of the present disclosure in which the self-collapsing of the cavity is obtained by having fuel recipient comprising a foldable (preferably accordion shaped) side wall suspended to a floating edge. It is noted that while the first and second variants merely differ from each other with respect to the wick arrangement, the third variant differ from the first and second variant with respect to the configuration of the fuel recipient. Therefore, for the sake of conciseness, the below description focuses on the discrepancies with respect to the first and second variants, being understood that details described in the first and second variants are generally compatible with the third variant (and vice versa). Particularly the wick arrangement according to any of the first and second variant is encompassed in the third variant. On FIG. 8, the candle system is shown with a wick arrangement 200 as described with reference to FIG. 4. The liquid candle system may include a wick arrangement and a fuel recipient 100 having a self-collapsing cavity 111 configured for accommodating a predetermined liquid fuel. The fuel recipient 100 may comprise a sidewall 120, a base wall 140 and a floating edge 170. The sidewall 120 may circumscribe (surround) laterally the self-collapsing cavity 111 and may be formed by a foldable (i.e. flexible, crumpling) film. The foldable film may be made of a non-elastic material. The base wall 140 may be coupled to the side wall 120 so as to form a bottom end of the self-collapsing cavity 111. The base wall 140 may be composed of a rigid plastic. An edge of the sidewall 120 may be coupled to the floating edge 170. In some embodiments, the floating edge 170 may have a ring shape and the edge of the sidewall 120 may be wrapped on the floating edge 170. The floating edge 170 may be made of a material configured to float on a predetermined liquid fuel 30. The cavity 111 may form an expendable recess configured for receiving the predetermined liquid fuel 30, for example olive oil. When the predetermined liquid fuel 30 is inserted in the cavity 111, the cavity 111 may expand telescopically (with respect to a vertical axis X). When the wick is lit by a flame 5 and the liquid fuel is consumed, the cavity 111 may retract telescopically with the level of the liquid fuel 30 decreasing. The fuel recipient 100 may further include a set of poles (not shown) configured to support the floating edge 170. In some embodiments, the poles may be telescopic. An opening of the cavity may enable fluid introduction in the cavity 111. A thickness of the foldable film may be between 30 and a few hundred microns, for example 300 microns. The foldable film may for example be composed of nylon and/or plastic. The floating edge 170 may be resistant to the heat generated by the burning wick. In some embodiments, the candle system according to the third variant, a second end of the wick is coupled to the base wall 140 and a clip (not shown) may further be provided to hold the wick standing. The clip may be provided with a center hole to allow the wick to protrude out of the clip. In other words, the fuel recipient may be composed of mostly soft collapsing plastic (for the side wall). As the cavity is filled, the floating edge connected to the top of the sidewall rises and picks up the collapsible plastic side wall with it. The floating edge may only be along (adjacent) the side wall and not cover the whole opening of the cavity. The wick may not be inserted in the floating edge. As the fire burns the liquid fuel, the floating edge lowers the side wall of the fuel recipient.

FIG. 9 illustrates a candle system according to a fourth variant including a self-collapsing cavity according to some embodiments of the present disclosure. The fourth variant may also be used with any of the two types of wick arrangements previously described. On FIG. 9, the candle system is shown with a wick arrangement 200 as described with reference to FIG. 4. The liquid candle system may include a wick and a fuel recipient 1000 having a self-collapsing cavity configured to accommodate a predetermined liquid fuel. The self-collapsing cavity may be formed by an elastic side wall 1012 mounted on an edge ring 1017. The edge ring 1017 may be arranged on poles 1014. The poles 1014 may be arranged vertically and configured for maintaining the ring edge 1017 perpendicular to the poles 1014. The elastic side wall 1012 may be made of a stretching material such that, when the predetermined liquid fuel is accommodated in the self-collapsing cavity, the self-collapsing cavity is stretched out by the predetermined liquid fuel, and when the cavity is filled with the predetermined liquid fuel and the first end of the wick is lit, the self-collapsing cavity stretches in with the predetermined liquid fuel being consumed.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A candle system comprising:
a fuel recipient comprising a self-collapsing cavity configured for receiving a predetermined liquid fuel; and
a wick;
wherein the self-collapsing cavity is configured for progressively collapsing when the cavity is filled with the predetermined liquid fuel and the wick is lit.

2. The candle system according to claim 1, wherein the wick is configured so that a first end of the wick protrudes out of an opening of the cavity when the self-collapsing cavity is filled with the predetermined liquid fuel.

3. The candle system according to claim 1, wherein the self-collapsing cavity is configured for collapsing at a pace similar to a decline pace of the predetermined liquid fuel in the cavity.

4. The candle system according to claim 1, wherein the self-collapsing cavity is composed of a stretching material, such that, when the predetermined liquid fuel is accommodated in the self-collapsing cavity, the self-collapsing cavity is stretched out by the predetermined liquid fuel, and when the cavity is filled with the predetermined liquid fuel and the wick is lit, the self-collapsing cavity stretches in with the predetermined liquid fuel being consumed.

5. The candle system according to claim 1, wherein the self-collapsing cavity is circumscribed by a side wall formed by a foldable film suspended to a floating edge so that the self-collapsing cavity expands when filled with the predetermined liquid fuel, and shrinks with the predetermined liquid fuel being consumed when the wick is lit.

6. The candle system according to claim 1, wherein the self-collapsing cavity is circumscribed by a side wall composed of a fusible material and the candle system is configured so that, when the cavity is filled with the predetermined liquid fuel and the wick is lit, an edge of the side wall fuses.

7. The candle system according to claim 1, further comprising a volume of the predetermined liquid fuel accommodated in the cavity.

8. A candle system comprising:
a fuel recipient comprising a self-collapsing cavity configured for receiving a predetermined liquid fuel; and
a wick;
wherein the candle system is further configured so that, when a predetermined volume of liquid fuel is inserted in the self-collapsing cavity, a first end of the wick protrudes out of the liquid fuel and, the first end of the wick being lit, the self-collapsing cavity collapses at a pace similar to a decline pace of the predetermined liquid fuel in the cavity.

9. The candle system according to claim 8, wherein the self-collapsing cavity is composed of a stretching material such that, when the predetermined liquid fuel is accommodated in the self-collapsing cavity, the self-collapsing cavity is stretched out by the predetermined liquid fuel, and when the predetermined liquid fuel is consumed, the self-collapsing cavity collapses.

10. The candle system according to claim 8, wherein the self-collapsing cavity is circumscribed by a side wall formed by a foldable film suspended to a floating edge configured to float on the predetermined liquid fuel so that when the cavity is filled with the predetermined liquid fuel and the first end of the wick is lit, the floating edge falls with the predetermined liquid fuel being consumed.

11. The candle system according to claim 8, wherein the self-collapsing cavity is circumscribed by a side wall composed of a fusible material and the candle system is configured so that, when the cavity is filled with the predetermined liquid fuel and the first end of the wick is lit, an edge of the side wall fuses.

12. The candle system according to claim 11, wherein when the cavity is filled with the predetermined liquid fuel and the first end of the wick is lit, a fusion of the edge of the side wall causes an opening of the cavity to decline at a pace similar to the pace at which the predetermined liquid fuel in the cavity declines.

13. The candle system according to claim 8, wherein the predetermined amount of liquid fuel fills the cavity up to an opening of the cavity.

14. The candle system according to claim 8 further configured so that the flame is visible out of the cavity during burning of the liquid fuel.

15. The candle system according to claim 8 further comprising the predetermined volume of the predetermined liquid fuel accommodated in the cavity.

16. A candle system comprising:
a fuel recipient comprising a self-collapsing cavity configured for receiving a predetermined liquid fuel;
a volume of the predetermined liquid fuel accommodated in the cavity so that the cavity is filled up to a reservoir surface;
a wick configured so that a first end of the wick protrudes out of the reservoir surface;
wherein the self-collapsing cavity is configured for progressively collapsing when the first end of the wick is lit.

17. The candle system according to claim 16, wherein the self-collapsing cavity is configured for collapsing, when the first end of the wick is lit, at a pace similar to a decline pace of the predetermined liquid fuel in the cavity.

18. The candle system according to claim 16 wherein the self-collapsing cavity is composed of a stretching material such that, the self-collapsing cavity is stretched out by the predetermined liquid fuel, and when the predetermined liquid fuel is consumed, the self-collapsing cavity progressively collapses.

19. The candle system according to claim 16, wherein the self-collapsing cavity is circumscribed by a side wall formed by a foldable film suspended to a floating edge configured to float on the predetermined liquid fuel so that when the cavity is filled with the predetermined liquid fuel and the first end of the wick is lit, the floating edge falls with the predetermined liquid fuel being consumed.

20. The candle system according to claim 16, wherein the self-collapsing cavity is circumscribed by a side wall composed of a fusible material and the candle system is configured so that, when the first end of the wick is lit, an edge of the side wall fuses.

21. The candle system according to claim 16, wherein the reservoir surface reaches an opening of the cavity.

22. The candle system according to any of claims 16 to 21, further configured so that the flame is visible out of the cavity during burning of the liquid fuel.

23. The candle system according to claim 16 further comprising a floater capable of floating on the predetermined liquid fuel and wherein the wick is arranged on the floater.

24. The candle system according to claim 16, wherein a second end of the wick is coupled to the self-collapsing cavity.

25. The candle system according to claim 24, further comprising a wick coating configured for strengthening the wick.

26. The candle system according to claim 25, wherein the wick coating is composed of a fusible material.

27. The candle system according to claim 26, wherein the wick coating is made of solid paraffin and/or wax.

28. The candle system according to claim 16, wherein the predetermined liquid fuel is olive oil.

29. The candle system according to claim 16, wherein a volume of the cavity up to the opening or up to the reservoir surface is adapted for enabling lighting of the candle system over a given period of time selected in the range from 30 minutes to 1 week, when the cavity is filled with olive oil.

30. The candle system according to claim 29, wherein the volume of the cavity up to the opening or up to the reservoir surface is adapted for enabling lighting of the candle system over a period of time selected from: 40 min, 90 min, 3 h, 6 h, 8 h, 24 h, 48 h, 72 h, 1 week, when the cavity is filled with olive oil.

31. The candle system according to claim 16, further comprising a fusible cover configured for covering the cavity, the wick being further configured for a first end of the wick to protrude out of the fusible cover, wherein the fusible cover is configured for fusing when the first end of the wick is lit.

32. The candle according to claim 31, wherein the fusible cover is composed of paraffin and/or wax.

33. The candle system according to claim 16, further comprising one or more additional wick arrangements.

34. The candle system according to claim 16, further comprising one or more additional fuel recipients.

35. A candle kit comprising:
one or more candle systems according to claim 16; and
one or more olive oil containers containing olive oil.

36. The candle system according to claim 1, further comprising a floater capable of floating on the predetermined liquid fuel and wherein the wick is arranged on the floater.

37. The candle system according to claim 8, further comprising a floater capable of floating on the predetermined liquid fuel and wherein the wick is arranged on the floater.

38. The candle system according to claim 1, wherein the wick has one of the following configurations: a second end of the wick is coupled to the self-collapsing cavity, the wick comprises a wick coating configured for strengthening the wick, the wick comprises a wick coating composed of a fusible material, the wick comprises a wick coating made of solid paraffin and/or wax.

39. The candle system according to claim 8, wherein the wick has one of the following configurations: a second end of the wick is coupled to the self-collapsing cavity, the wick comprises a wick coating configured for strengthening the wick, the wick comprises a wick coating composed of a fusible material, the wick comprises a wick coating made of solid paraffin and/or wax.

40. The candle system according to claim 1, wherein the predetermined liquid fuel is olive oil.

41. The candle system according to claim 8, wherein the predetermined liquid fuel is olive oil.

42. The candle system according to claim 1, wherein a volume of the cavity up to the opening or up to the reservoir surface is adapted for enabling lighting of the candle system over a given period of time selected in the range from 30 minutes to 1 week, when the cavity is filled with olive oil.

43. The candle system according to claim 8, wherein a volume of the cavity up to the opening or up to the reservoir surface is adapted for enabling lighting of the candle system over a given period of time selected in the range from 30 minutes to 1 week, when the cavity is filled with olive oil.

44. The candle system according claim 1, further comprising a fusible cover configured for covering the cavity, the wick being further configured for a first end of the wick to protrude out of the fusible cover, wherein the fusible cover is configured for fusing when the first end of the wick is lit.

45. The candle system according claim 8, further comprising a fusible cover configured for covering the cavity, the wick being further configured for a first end of the wick to protrude out of the fusible cover, wherein the fusible cover is configured for fusing when the first end of the wick is lit.

46. The candle system according to claim 1, further comprising one or more additional wick arrangements.

47. The candle system according to claim 8, further comprising one or more additional wick arrangements.

48. The candle system according to claim 1, further comprising one or more additional fuel recipients.

49. The candle system according to claim 8, further comprising one or more additional fuel recipients.

50. A candle kit comprising:
one or more candle systems according to claim 1; and
one or more olive oil containers containing olive oil.

51. A candle kit comprising:
one or more candle systems according to claim 8; and
one or more olive oil containers containing olive oil.
